(19) United States
(12) Patent Application Publication
(10) Pub. No.: US 2026/0169615 A1
(43) Pub. Date: Jun. 18, 2026

(54) CONTEXTUAL SWIPE

(71) Applicant: Google LLC, Mountain View, CA (US)

(72) Inventors: Cameron Oelsen, Sunnyvale, CA (US); Vitalii Ampilogov, Santa Clara, CA (US)

(21) Appl. No.: 18/980,910

(22) Filed: Dec. 13, 2024

(51) Int. Cl. G06F 3/0484; G06F 3/0482; G06F 3/04883

(52) U.S. Cl. CPC G06F 3/0484; G06F 3/0482; G06F 3/04883

(57) ABSTRACT

Aspects of the technology provide a computer-implemented method. The method may include detecting, by one or more user input mechanisms of a user computing device, a first user action, wherein the first user action includes interaction with a suggestion of a plurality of suggestions; generating, by one or more processors of the user computing device, content in response to the first user action, wherein the content includes a visual preview of the suggestion of the plurality of suggestions; detecting, by the one or more user input mechanisms of the user computing device, a second user action, wherein the second user action is different from the first user action; and generating, by the one or more processors of the user computing device, updated content for visual presentation based on the second user action.

### BACKGROUND

Users are able to accept selections on their computing devices when performing various actions. In addition, a user may be able to accept selections based on one or more suggestions presented to them. In this regard, making selections of suggestions may require multiple disjointed steps on the part of the user, such as multiple separate selection actions like tapping icons. Such disjointed steps are inefficient and may lead to less use or interest in a feature. Requiring multiple selections or other actions can also reduce the likelihood of a user accepting a suggestion.

### BRIEF SUMMARY

Aspects of the technology provide a computer-implemented method. The method may include detecting, by one or more user input mechanisms of a user computing device, a first user action, wherein the first user action includes interaction with a suggestion of a plurality of suggestions; generating, by one or more processors of the user computing device, content in response to the first user action, wherein the content includes a visual preview of the suggestion of the plurality of suggestions; detecting, by the one or more user input mechanisms of the user computing device, a second user action, wherein the second user action is different from the first user action; and generating, by the one or more processors of the user computing device, updated content for visual presentation based on the second user action.

In one example, the one or more user input mechanisms may include a touchscreen and the first user action may include applying pressure on the touchscreen. Additionally, the second user action may include no longer applying pressure on the touchscreen.

In another example, the second user action may include a directional swipe in a particular direction along the user computing device. Additionally, the directional swipe may be along an axis of the user computing device. Additionally or alternatively, the directional swipe may be towards and terminate at an icon of the visual preview. Additionally or alternatively, the directional swipe may be indicative of user acceptance of the suggestion of the plurality of suggestions and the updated content may include a visual transition of the suggestion from the visual preview to an accepted state. Additionally or alternatively, the directional swipe may be indicative of user rejection of the suggestion of the plurality of suggestions the updated content may include removal of the visual preview.

In a further example, the plurality of suggestions may include a plurality of responses to an electronic message which may be generated by a large language model (LLM).

In an additional example, the method may further include generating haptic feedback in response to at least one of the first user action and the second user action.

Another aspect of the disclosure is directed towards a user computing device. The user computing device may include one or more user input mechanisms configured to detect user actions; and one or more processors operatively connected to the one or more user input mechanisms. The one or more processors may be configured generate, content in response to a first user action, wherein the content includes a visual preview of a suggestion of a plurality of suggestions and wherein the first user action includes interaction with the suggestion of the plurality of suggestions, and generate updated content for visual presentation based on a second user action.

In one example, the one or more user input mechanisms may include at least one of a touchscreen and a trackpad.

In another example, the user computing device may be a mobile device or a laptop computer.

In a further example, the second user action may include a directional swipe in a particular direction along the user computing device. Additionally, the directional swipe may be along an axis of the user computing device. Additionally or alternatively, the directional swipe may be indicative of user acceptance of the suggestion of the plurality of suggestions or user rejection of the suggestion of the plurality of suggestions.

In an additional example, the directional swipe may be along a first axis of the user computing device when indicative of user acceptance and may be along a second axis of the user computing device when indicative of user rejection.

In another example, the directional swipe may be in a first direction along a first axis of the user computing device when indicative of user acceptance and may be in a second direction along the first axis of the user computing device when indicative of user rejection.

### BRIEF DESCRIPTION OF THE DRAWINGS

FIG. 1 illustrates a client mobile computing device in accordance with aspects of the technology.

FIG. 2 is a block diagram of a client mobile computing device in accordance with aspects of the technology.

FIG. 3 illustrates a client computing device in accordance with aspects of the technology.

FIG. 4 is a block diagram of a client computing device in accordance with aspects of the technology.

FIG. 5 illustrates an example method in accordance with aspects of the technology.

FIGS. 6A-D illustrate an example display in accordance with aspects of the disclosure.

FIGS. 7A-B illustrate an example display in accordance with aspects of the disclosure.

FIG. 8 illustrates an example display in accordance with aspects of the disclosure.

### DETAILED DESCRIPTION

### Overview

Aspects of the technology generally pertain to quickly and efficiently allowing a user to preview and accept a suggestion while using their computing device, via a fluid motion. In one scenario, a user may preview and then accept a suggestion of, for example, text and/or other information generated by a large language model (LLM) or other machine learning (ML) model. In some instances, the suggestion and/or preview thereof may include imagery or audio information.

Typically, a user may go through several disjointed steps to accept a suggestion presented on their computing device. The disjointed steps may or may not include a preview of the suggestion. Such steps may also require the user to lift up their finger and tap to select. Such disjointed steps may lead to less use or interest in a feature. They may also reduce the likelihood that a user will accept a suggestion presented in that manner.

To address this, as noted above, a fluid motion may allow a user to preview and accept a suggestion (e.g., preview and select text generated by an LLM). In this regard, to preview such a text suggestion, a user may engage or press, using an input mechanism, on text to view preview thereof. Then, the user may swipe, using the input mechanism, in a particular direction to confirm the suggestion. Alternatively, the user may not swipe and disengage or release, using the input mechanism. Following disengagement, a new suggestion may or may not be previewed.

### Example Systems

Unless otherwise stated, the disclosed examples and scenarios are not mutually exclusive, but may be implemented in various combinations to achieve unique advantages. As these and other variations and combinations of the features discussed above can be utilized without departing from the subject matter defined by the claims, the description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

The following discusses examples of user computing devices which may be used in conjunction with the technology presented herein. These examples are not intended to limit the scope of the technology.

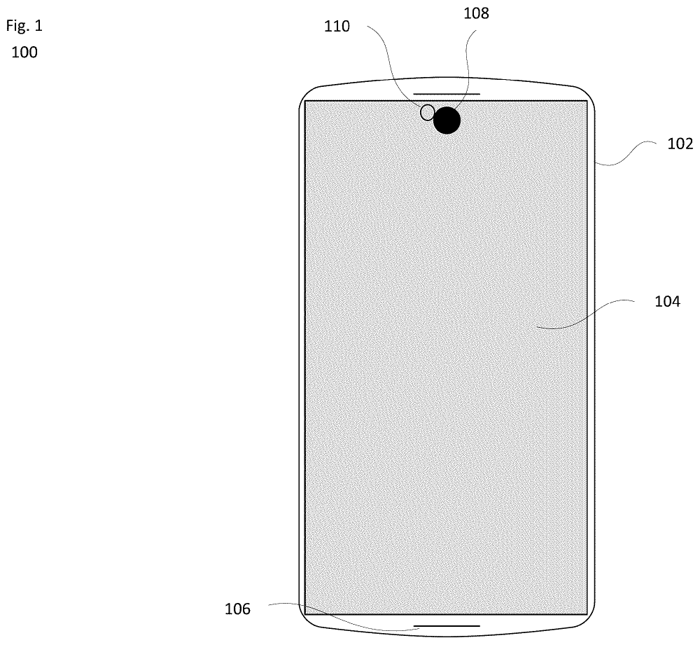

As discussed above, a user may preview and accept a suggestion while using a user computing device using a fluid motion. In one example, the user computing device may be a mobile device (e.g., cell phone, tablet, a wearable device such as a smartwatch or head-mounted display, etc.). The mobile device may include one or more user input mechanisms configured to detect user actions. FIG. 1 illustrates an example 100 showing a handheld-type client mobile device 102, such as a smartphone, tablet, personal digital assistant (PDA) or a smartwatch, etc. In this example, there is a display or touchscreen 104 for visually presenting content to the user via a graphical user interface (GUI).

Additionally in this example, the client mobile device 102 includes one or more user input mechanisms configured to detect user actions. In this regard, the touchscreen 104 may also be configured as a user input mechanism. A microphone 106 may be provided as an audible user input mechanism. An integrated camera 108 can be used for capturing photos, videoconferences, interactive gaming, etc. The integrated camera 108 may be configured as a user input mechanism. Contactless gesture input, such as using a close-range radar or ultrasonic sensor (not shown), may also be employed, either in addition or in the alternative, to the other types of input. Indicator 110, such as an LED, may be illuminated to alert a user whenever the integrated camera 108 is in use.

The user actions may include user engagement and user disengagement. The user engagement may include, for example, applying pressure or pressing on touchscreen 104. The user engagement may additionally include a directional action (e.g., swiping in a particular direction across the touchscreen 104). User disengagement may include, for example, no longer pressing on the touchscreen 104 of the mobile device 102. The mobile device 102 may contain additional user input mechanisms configured to detect user engagement (e.g., one or more buttons, audio and/or gesture-based inputs, one or more sensors, etc.).

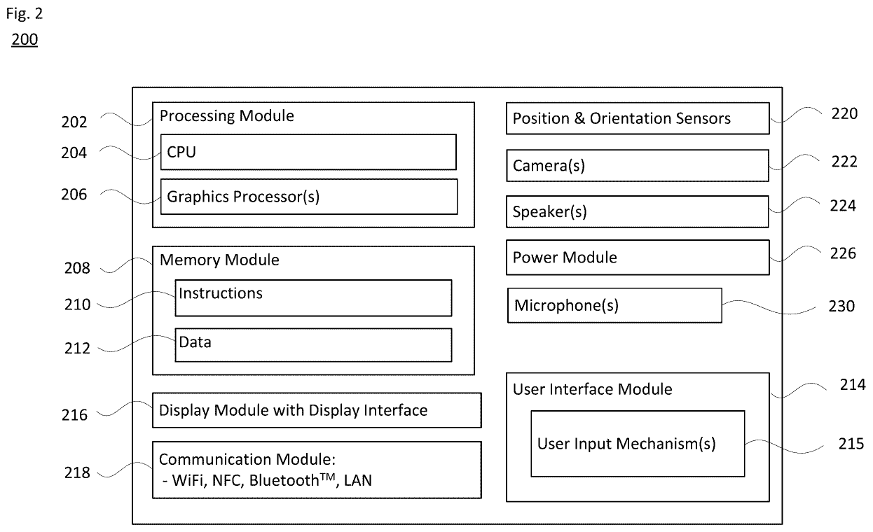

FIG. 2 illustrates a block diagram of an example handheld client mobile device 200, such as the smartphone shown in FIG. 2. As shown, the client mobile device 200 includes a processing module 202 having one or more processors such as a central processing unit 204 and/or graphics processors 206, as well as memory module 208 configured to store instructions 210 and data 212. The one or more processors of the processing module 202 may be any conventional processors, such as commercially available CPUs. Alternatively, the one or more processors may include a dedicated device such as an ASIC, graphics processing unit (GPU), tensor processing unit (TPU), and/or other hardware-based processors. The one or more processors may or may not operate in parallel, and may include ASICs, controllers, and other types of hardware circuitry. The one or more processors may be configured to receive information from a user through user interface module 214, and to present information to the user on one or more display devices of the display module 216 having a display interface.

User interface module 214 may receive commands or other input information from a user via one or more user input mechanisms 215 and convert them for submission to a given processor. The user interface module 214 may link to a web browser and other applications executed by the mobile device's processing module 202. The one or more user input mechanisms may include a touchscreen configured to detect user actions. The user actions may include user engagement and user disengagement. The user engagement may include, for example, applying pressure or pressing on the touchscreen, or performing a pressing-type gesture. The user engagement may additionally include a directional action (e.g., swiping in a particular direction, such as across the touchscreen). User disengagement may include, for example, no longer pressing on the touchscreen of the user computing device or otherwise ceasing a pressing-type gesture. The one or more user input mechanisms 215 may additionally include one or more of a stylus, microphone, one or more buttons, audio and/or gesture-based inputs, camera (e.g., such as camera 222), one or more other sensors, etc.

The display module 216 may comprise appropriate circuitry for driving the display device to present graphical and other information to the user. By way of example, the graphical information may be generated by the graphics processor(s) 206, while CPU 204 manages overall operation of the client mobile device 200. The graphical information may display responses to user queries on the display module 216. For instance, the processing module may run an application or other service using instructions and data stored in memory module 208, and present information associated with the application or other service to the user via the display module 216. The memory module may include a database or other storage for application-related information, etc.

Memory module 208 can be implemented as one or more of a computer-readable medium or media, a volatile memory unit or units, or a non-volatile memory unit or units. The memory module 208 may include, for example, flash memory and/or NVRAM, and may be embodied as a hard-drive or memory card. One or more regions of the memory module 208 may be write-capable while other regions may comprise read-only (or otherwise write-protected) memories.

The data 212 may be retrieved, stored, or modified by the processors in accordance with the instructions 210. For instance, the data may be stored in computing device registers, in a relational database as a table having a plurality of different fields and records, XML documents or flat files. The data may also be formatted in any computing device-readable format.

The instructions 210 may be any set of instructions to be executed directly (such as machine code) or indirectly (such as scripts) by the processor(s). For example, the instructions may be stored as mobile device code on the mobile device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 2, the client mobile device 200 includes a communication module 218 for communicating with other devices and systems, including other client devices, servers, and databases. The communication module 218 includes a wireless transceiver. The client device 200 may communicate with other remote devices via the communication module 218 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, WiFi and HTTP, and combinations of the foregoing.

The example client device 200 as shown also includes one or more position and orientation sensors 220. The position and orientation sensors 220 are configured to determine the position and orientation of one or more parts of the client mobile device 200. For example, these components may include a GPS receiver or other global positioning component to determine the device's latitude, longitude and/or altitude as well as an accelerometer, gyroscope or another direction/speed detection device such as an inertial measurement unit (IMU). The mobile device 200 may also include one or more camera(s) 222 for capturing still images and recording video streams such as the integrated camera as discussed above, speaker(s) 224. Power module 226 provides power to the various system components. In addition, user inputs may include a microphone 230, which may comprise a microphone array having one or more transducers or other microphone elements distributed at various points along the housing of the computing device.

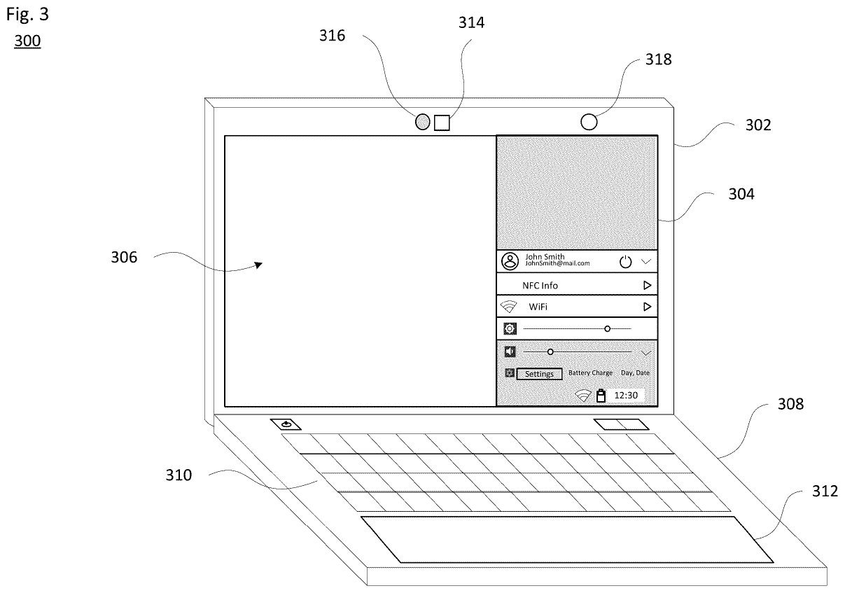

In another example, the user computing device may be a laptop computer. FIG. 3 illustrates an example 300 showing a client computing device 302, such as a laptop computer. In this example, there is a display 304 for visually presenting content via GUI 306, and a user input mechanism section 308 including one or more user input mechanisms configured to detect user actions. In this regard, the display 304 may be configured as a user input mechanism (e.g., a touchscreen). The one or more user input mechanisms further include a keyboard 310 and a trackpad 312 as different user inputs. A microphone (not shown) may be provided as an audible user input mechanism. The keyboard 310 may be a virtual keyboard, for instance as part of another display. While one trackpad 312 is shown, the device may have two or more trackpads arranged thereon. The device may contain additional user inputs (e.g., a mouse, audio and/or gesture-based inputs).

An integrated webcam 314 can be used for videoconferences, interactive gaming, etc. The integrated webcam 314 may be configured as a user input mechanism. Indicator 316, such as an LED, may be illuminated to alert a user whenever the integrated webcam is in use. The client device may also include one or more other sensors 318, which may be used to supplement visual information obtained by the webcam 314. By way of example, the one or more other sensors may include an additional imaging device, an RF- or ultrasonic-based motion sensor, such as to help identify gestures by the user or act as a human presence detector.

The user actions may include user engagement and user disengagement. The user engagement may include, for example, applying pressure or pressing on display 304 when configured as a touchscreen, trackpad 312, and/or a mouse (not shown). The user engagement may additionally include a directional action (e.g., swiping in a particular direction across the display 304 via display 304 when configured as a touchscreen, trackpad 312, and/or a mouse). User disengagement may include, for example, no longer applying pressure or pressing.

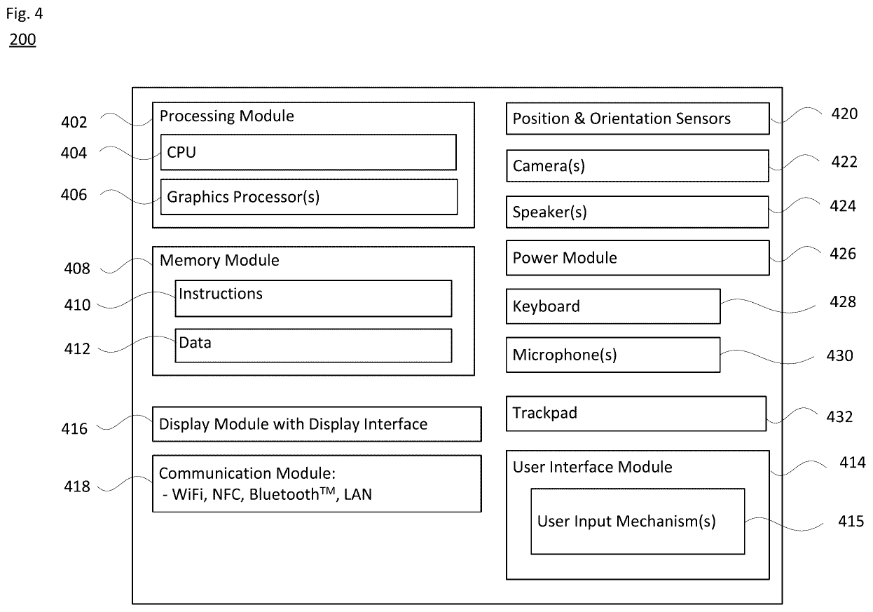

FIG. 4 illustrates a block diagram of an example client computing device 400, such as the laptop shown in FIG. 3 (e.g., a tablet PC or netbook), a desktop PC, an in-home device such as a smart display, or the like. As shown, the client computing device 400 includes a processing module 402 having one or more processors such as a central processing unit 404 and/or graphics processors 406, as well as memory module 408 configured to store instructions 410 and data 412. The one or more processors of the processing module 402 may be any conventional processors, such as commercially available CPUs. Alternatively, the one or more processors may include a dedicated device such as an ASIC, graphics processing unit (GPU), tensor processing unit (TPU), and/or other hardware-based processors. The one or more processors may or may not operate in parallel, and may include ASICs, controllers, and other types of hardware circuitry. The one or more processors may be configured to receive information from a user through user interface module 414, and to present information to the user on one or more display devices of the display module 416 having a display interface.

User interface module 414 may receive commands or other input information from a user via one or more user input mechanisms 415 (which may include any of the sensors/input elements discussed above) and convert them for submission to a given processor. The user interface module 414 may link to a web browser and other applications executed by the computing device's processing module 402. The one or more user input mechanisms may include a touchscreen configured to detect user actions. The user actions may include user engagement and user disengagement. The user engagement may include, for example, applying pressure or pressing on the touchscreen. The user engagement may additionally include a directional action (e.g., swiping in a particular direction across the touchscreen). User disengagement may include, for example, no longer pressing on the touchscreen of the user computing device. The one or more user input mechanisms may additionally include one or more of a stylus, microphone, one or more buttons, audio and/or gesture-based inputs, camera, one or more sensors, etc.

The display module 416 may comprise appropriate circuitry for driving the display device to present graphical and other information to the user. By way of example, the graphical information may be generated by the graphics processor(s) 406, while CPU 404 manages overall operation of the client device 400. The graphical information may display responses to user queries or other content on the display module 416. For instance, the processing module may run a browser application, messaging application or other service using instructions and data stored in memory module 408, and present information associated with the browser application or other service to the user via the display module 416. The memory module may include a database or other storage for application-related information, etc.

Memory module 408 can be implemented as one or more of a computer-readable medium or media, a volatile memory unit or units, or a non-volatile memory unit or units. The memory module 408 may include, for example, flash memory and/or NVRAM, and may be embodied as a hard-drive or memory card. Alternatively or additionally, the memory module 408 may also include removable media (e.g., DVD, CD-ROM or USB thumb drive). One or more regions of the memory module 408 may be write-capable while other regions may comprise read-only (or otherwise write-protected) memories. In one implementation, a computer program product is tangibly embodied in an information carrier. Although FIG. 4 functionally illustrates the processor(s), memory module, and other elements of client computing device 400 as being within the same overall block, such components may or may not be stored within the same physical housing. For example, some or all of the instructions and data may be stored on an information carrier that is a removable storage medium (e.g., optical drive, high-density tape drive or USB drive) and others stored within a read-only computer chip.

The data 412 may be retrieved, stored, or modified by the processors in accordance with the instructions 410. For instance, the data may be stored in computing device registers, in a relational database as a table having a plurality of different fields and records, XML documents or flat files. The data may also be formatted in any computing device-readable format.

The instructions 410 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 4, the client device 400 includes a communication module 418 for communicating with other devices and systems, including other client devices, servers and databases. The communication module 418 includes a wireless transceiver; alternatively, the module may alternatively or additionally include a wired transceiver. The client device 400 may communicate with other remote devices via the communication module 418 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, Ethernet, WiFi and HTTP, and combinations of the foregoing.

The example client device 400 as shown also includes one or more position and orientation sensors 420. The position and orientation sensors 420 are configured to determine the position and orientation of one or more parts of the client computing device 400. For example, these components may include a GPS receiver or other global positioning component to determine the device's latitude, longitude and/or altitude as well as an accelerometer, gyroscope or another direction/speed detection device such as an inertial measurement unit (IMU). The client device 400 may also include one or more camera(s) 422, which may be part of or separate from the user interface module 414, for capturing still images and recording video streams such as the integrated webcam as discussed above, speaker(s) 424. Power module 426 provides power to the various system components. In addition, user input mechanisms 415 may include a keyboard 428 and a microphone 430, which may comprise a microphone array having one or more transducers or other microphone elements distributed at various points along the housing of the computing device. Trackpad 432, as another user input mechanism, may include either a capacitive touch sensor unit 434a or a piezoelectric sensor unit 434b (or both).

### Example Methods

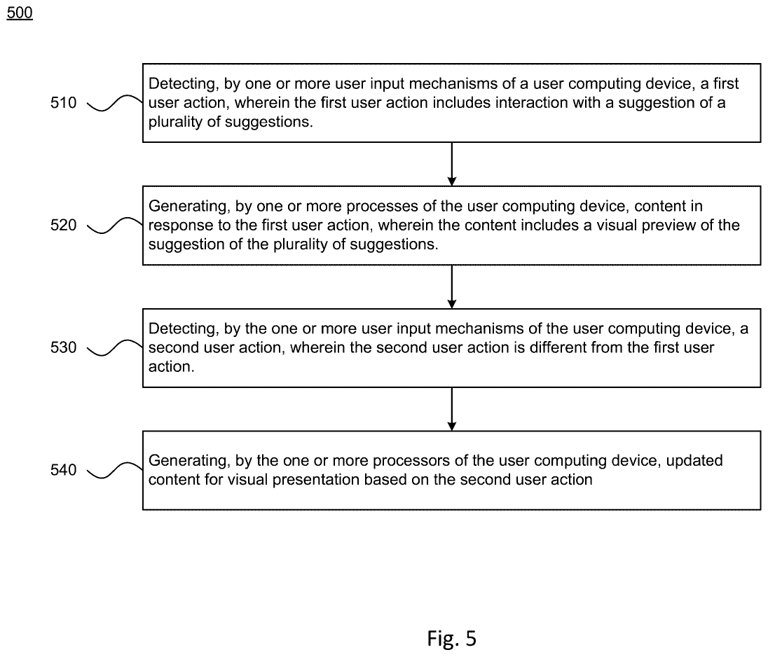

As discussed above, a fluid motion may allow a user to preview and accept a suggestion (e.g., preview and select text generated by an LLM). The fluid motion may be used in a computer-implemented method. FIG. 5 illustrates an example computer-implemented method 500. At block 510, method 500 includes detecting, by one or more user input mechanisms of a user computing device, a first user action, wherein the first user action includes interaction with a suggestion of a plurality of suggestions that has been presented to the user. In this regard, one or more user input mechanisms as discussed above, such as a touchscreen 104, 304 or trackpad 312, of a user computing device (e.g., the mobile device 102, 200 or the laptop computer 302, 400) may detect a first user action. The first user action may be user engagement with a suggestion of a plurality of suggestions. The user engagement may include applying pressure or pressing on the touchscreen or trackpad 312 at a location associated with a given one of the suggestions.

The user engagement may alternatively include otherwise interacting with, via one or more of the user input mechanisms discussed above, a suggestion of the plurality of suggestions at the location of the suggestion. For example, the plurality of suggestions may be a plurality of responses generated by an LLM to a received email or other electronic message (e.g., a text message or a chat message). Each of the plurality of responses may be different text responses generated by the LLM based on the message received by the user's computing device. The different responses may be of varying length (e.g., a short 1-2 sentence response, a medium response of a paragraph, and a long response of multiple paragraphs), have different tones or styles (e.g., formal versus informal), and/or otherwise respond to the received email in alternative ways. In such an example, a user may press on or otherwise select one of the plurality of text responses. In some instances, the user computing device may generate haptic feedback in response to the first user action. Such haptic feedback may include vibration of the user computing device 102, 200, 302, 400.

In another example, the plurality of sections may be a plurality of applications of the user computing device. In such an example, a user may press on or otherwise select one of the plurality of applications. In a further example, the preview may include a template, such as a document template. In such an example where the plurality of suggestions is a plurality of document templates, the preview may be a preview of one of the templates.

At block 520, the method 500 further includes generating, by one or more processes of the user computing device, content in response to the first user action, wherein the content includes a preview of the suggestion of the plurality of suggestions. In this regard, the one or more processors 202, 402 of the user computing device 102, 200, 302, 400 may generate context including a visual preview to be displayed (and/or audibly presented) in response to the first user action. The preview may be a preview of the suggestion of the plurality of suggestions.

The preview may have a first appearance (e.g., a preview color, shading, font, size, additional icon or other graphical indicia, etc., or any combination thereof). Continuing on the above example where the plurality of suggestions may be a plurality of responses generated by an LLM to an email (or other electronic message), the preview may include the suggestion inserted into a draft reply email of the user. In this regard, the one text response interacted with by the user may be inserted into a draft email. The draft email may be a draft responsive to the email received by the user. In such an example, the text of the draft email may have at least one of a color, font, size, opacity, etc. different from a default color, font, size, opacity, etc. Pertaining to color, in this example the text of the preview may be light gray in color when a default email text color is black.

In another example, the preview may be a preview of a different page, application, etc. In such an example where the plurality of suggestions is a plurality of applications of the user computing device, the preview may be a preview of an application. The preview of the application may illustrate a page of the application to be loaded if the suggestion is confirmed (e.g., the preview may include a view of the current month if the application is a calendar application).

In a further example, the preview may include a template, such as a document template. In such an example where the plurality of suggestions is a plurality of document templates, the preview may be a preview of the template. The preview of the template may illustrate one or more pages of the document template to be loaded if the suggestion is confirmed (e.g., the preview may include the document template in a preview color).

Additionally or alternatively, in some instances, an icon may be generated with the preview. In this regard, the icon may be an arrow or other icon. In one example, such as the above example where the plurality of suggestions may be a plurality of responses to an email generated by an LLM, the arrow may be above the plurality of suggestions. The arrow is in the direction of the text placement. As such, the arrow points from the plurality of suggestions in the direction of insertion of the text into the draft email.

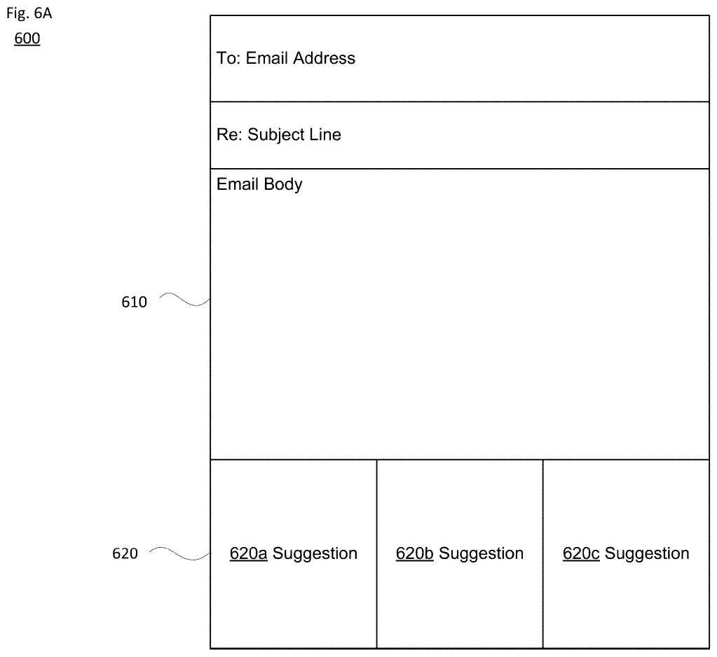

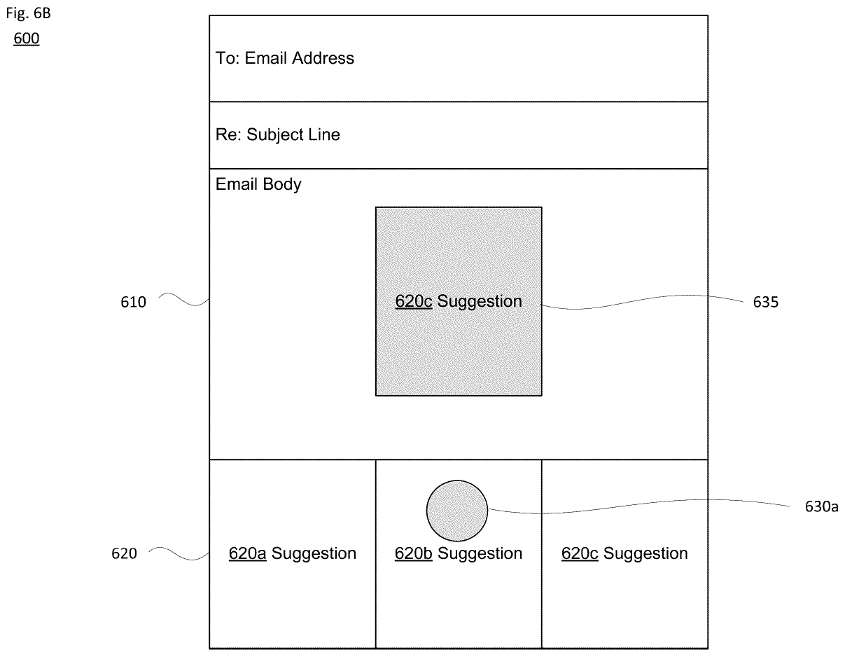

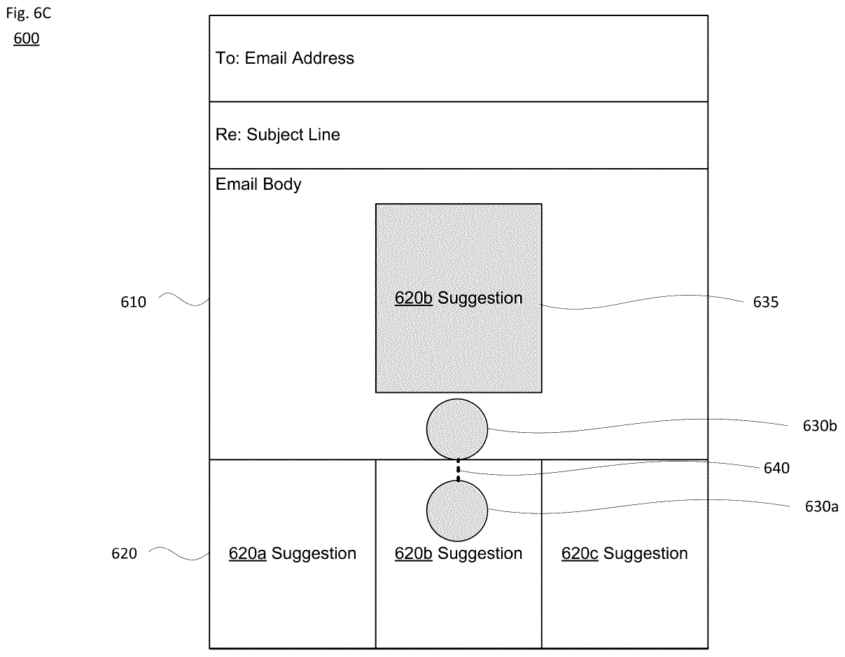

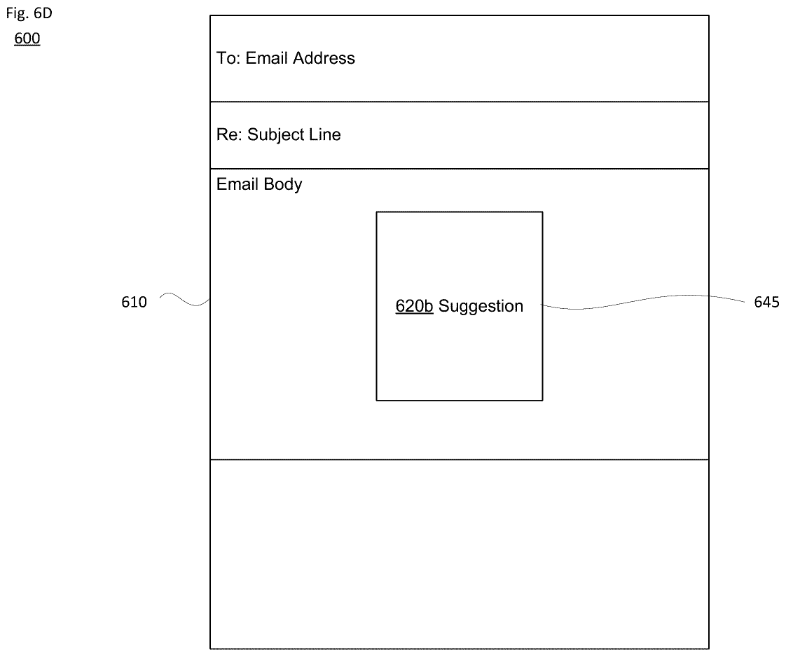

FIG. 6A illustrates an example display 600 of a client computing device (e.g., the mobile device 102, 200 or the laptop computer 302, 400) including a draft email having an email body 610 and a plurality of suggestions 620. In this example, the email body 610 is blank. Moreover, the plurality of suggestions 620 may be a plurality of responses to an email generated by an LLM as discussed above. While FIG. 6A illustrates three suggestions 620a-c, there may be more or less suggestions presented to a user. In one scenario, the suggestions 620 may be presented as suggestion chips.

FIG. 6B illustrates the example display 600 that has detected a first user action 630a and generated visual content 635. In this regard, the first user action 630a may include user engagement with a suggestion 620b of a plurality of suggestions 620. The user engagement may include applying pressure or pressing on display 600, when configured as a touchscreen, or a trackpad associated therewith, at a location of a suggestion. The user engagement may alternatively include clicking or otherwise interacting with, via one or more of the user input mechanisms discussed above, the suggestion 620b of the plurality of suggestions 620 at the location of the suggestion.

FIG. 6B further illustrates visual content 635 generated by one or more processors 202, 402 of the user computing device (e.g., the mobile device 102, 200 or the laptop computer 302, 400). The visual content may be generated in response to the first user action 630a. As illustrated, the visual content 635 is a preview of the suggestion 620b of the plurality of suggestions 620. In this regard, the visual content 635 includes the suggestion 620b inserted into the email body 610 of a draft email. The visual content 635 may have a first appearance (e.g., a preview color, shading, font, size, additional icon or other graphical indicia, etc.). The first appearance may have at least one of a color, font, size, opacity, etc. different from a default color, font, size, opacity, etc.

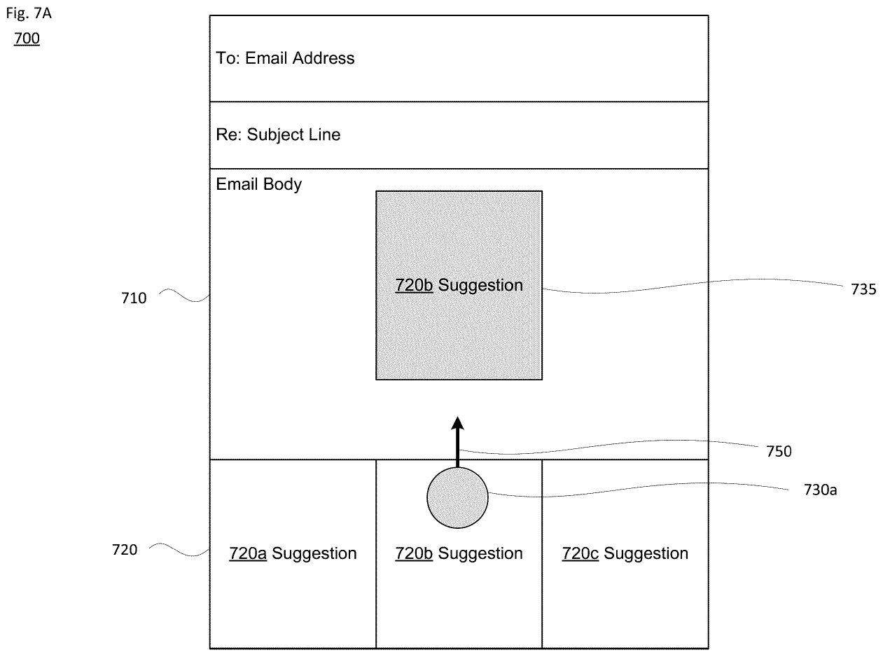

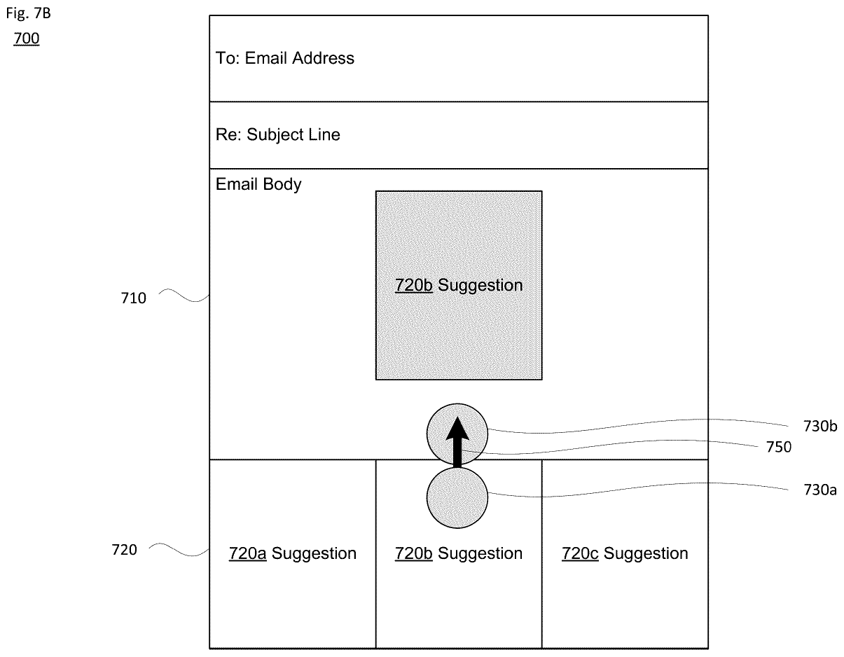

As stated above, in some instances, an icon may be generated with the visual content. FIG. 7A illustrates an example display 700 including visual content 735 and icon 750 generated by one or more processors of the user computing device (e.g., the mobile device 102, 200 or the laptop computer 302, 400). In this example, icon 750 is illustrated as an arrow. Icon 750 is generated above the plurality of suggestions 720. The icon 750 is oriented in the direction of placement of the suggestion 720b. In this regard, icon 750 points from the plurality of suggestions in the direction of insertion of the suggestion 720b into the email body 710 of the draft email. This, the icon shows where in the draft email the suggestion would be inserted.

At block 530, the method further includes detecting, by the one or more user input mechanisms of the user computing device, a second user action, wherein the second user action is different from the first user action. In this regard, the one or more user input mechanisms, such as the touchscreen 104, 304 or trackpad 312, of the user computing device (e.g., the mobile device 102, 200 or the laptop computer 302, 400) may detect a second user action. In some instances, the second user action may be indicative of user acceptance of the previewed suggestion. In such an instance, the second user action may be user engagement different from the user engagement of the first user action.

The second user action may include a directional swipe (e.g., swiping in a particular direction across the touchscreen). The directional swipe may be a swiping motion along the display 104, 304, using the one or more user input mechanisms, of the user computing device 102, 200, 302, 400 in a particular direction. The directional swipe may terminate when the user releases or no longer presses on the touchscreen 104, 304 or trackpad 312. In some instances, the direction may be approximately along an axis of the display 104, 304 of the user computing device 102, 200, 302, 400 (e.g., x-axis, y-axis). In one example, if the directional swipe is not approximately along an axis of the display 104, 304 of the user computing device or includes a second directional swipe in a different direction, the second user action may be indicative of user rejection of the previewed suggestion.

In another example, a directional swipe may perform a different action (e.g., refining the text in the preview). The directional swipe performing a different action may be different from the directional swipe indicative of user acceptance. In this regard, the directional swipe indicative of acceptance may be along a first axis and the directional swipe that may perform a different action may be along a second axis; the directional swipe indicative of acceptance may be in a first direction along a first axis and the directional swipe that may perform a different action may in a second direction along a second axis, etc.

Additionally, in some instances, the user computing device 102, 200, 302, 400 may generate haptic feedback in response to the second user action. Such haptic feedback may include vibration of a portion of the user computing device. Additionally or alternatively, the direction may be towards the center of the display 104, 304 of the user computing device 102, 200, 302, 400.

Additionally or alternatively, when an icon is generated with the preview, the directional swipe may be towards and terminate at or on the icon. In such an instance, if the directional swipe does not terminate at or on the icon, the second user action may be indicative of user rejection of the previewed suggestion. For example, when the icon is an arrow as illustrated above, the directional swipe may be towards and terminate at or on the arrow. The arrow may change in appearance in response to the directional swipe (e.g., change color, size, font, etc.). Alternatively, if the directional swipe does not terminate at the arrow, the second user action may be indicative of user rejection of the previewed suggestion. Here, the system may compare the path of the directional swipe to the direction of the arrow. If they are not the same, or the swipe path differs from the direction of the arrow by more than a threshold amount (e.g., 5 degrees, or more or less), then the system may determine that the user has rejected the previewed suggestion.

In some instances, the second user action may be indicative of user rejection of the previewed suggestion. In one example, the second user action may be user disengagement. For example, the second user action may include no longer pressing on the touchscreen of the user computing device. In another example, the second user action may be a directional swipe indicative of user rejection. In such an example, a directional swipe indicative of user rejection may be different from a user swipe indicative of user acceptance. In this regard, the directional swipe indicative of acceptance may be along a first axis and the directional swipe indicative of user rejection may be along a second axis; the directional swipe indicative of acceptance may be in a first direction along a first axis and the directional swipe indicative of user rejection may in a second direction along a second axis, etc.

Returning to FIG. 5, at block 540, the method further includes generating, by the one or more processors of the user computing device, updated content for visual presentation based on the second user action. In this regard, the one or more processors 202, 402 of the user computing device 102, 200, 302, 400 may generate updated content based on the second user action. When the second user action is indicative of user acceptance of the previewed suggestion, the updated content may include a visual transition of the suggestion from the preview to an accepted state. The accepted state may be a “final” state, such as when the LLM-generated text is ready to send in a responsive email. Alternatively, the accepted state may enable the user to edit the generated text. Here, a cursor may be inserted at the end of the draft text for editing purposes.

The accepted state may have a second appearance different from the first (e.g., an accepted or default color, shading, font, size, additional icon or other graphical indicia, etc.). Continuing on the above example where the plurality of suggestions may be a plurality of responses to an email generated by an LLM, the accepted state may include the one of the plurality of text responses inserted into the draft reply email of the user. In such an example, the text of the draft email may be at least one of the default color, shading, font, size, opacity, etc. different from the preview color, font, size, opacity, etc. Pertaining to color, in this example the text of the preview may be light gray in color and following the second user action, the text may be black, the default email text color.

Alternatively, when the second user action is indicative of user rejection of the previewed suggestion, the updated content may include removal of the preview may be or a return to an original state. Continuing on the above example where the plurality of suggestions may be a plurality of responses to an email generated by an LLM, the removal of the preview may include removing the selected text suggestion from the draft email.

In some instances, the updated content may include a “snackbar” including an undo feature. The undo feature may allow a user to transition from the accepted state to the original state.

FIG. 6C illustrates the example display 600 of the client computing device (e.g., the mobile device 102, 200 or the laptop computer 302, 400) further including a second user action 630b indicative of acceptance of the suggestion. The second user action 630b as illustrated may be indicative of user acceptance of the previewed suggestion. The second user action 630b is user engagement different from the user engagement of the first user action 630a. The second user action 630b includes a directional swipe. The directional swipe may be a swiping motion along the display 600, using the one or more user input mechanisms, of the user computing device in a particular direction. As illustrated, the direction is approximately along an axis 640, corresponding to the y-axis of the display. The directional swipe may terminate when the user releases or no longer engages with the one or more user input mechanisms (e.g., no longer presses on the touchscreen 104, 304 or trackpad 312).

While illustrated as a directional swipe along the y-axis, this is merely meant as an example. In this regard, the directional swipe may be along the x-axis or along a different axis. Alternatively, the swipe may be in a plurality of directions so long as the directional swipe terminates at a location approval along the y-axis, the x-axis, or other axis.

FIG. 6D illustrates display 600 including generated update visual content 645 based on the second user action 630b. The updated visual content 645 includes a transition of the suggestion from the preview to an accepted state. The accepted state may be a “final” state, such as when the LLM-generated text is ready to send in a responsive email. Alternatively, the accepted state may enable the user to edit the generated text. Here, a cursor may be inserted at the end of the draft text for editing purposes. The accepted state may have a second appearance different from the first appearance of the preview in the generated visual content 635 (e.g., an accepted or default color, shading, font, size, additional icon or other graphical indicia, etc.).

In other instances, the second user action may be indicative of user rejection of the previewed suggestion. In such an instance, the second user action may be any action other than the second user action 630b indicative of acceptance. In some instances, this second user action may be user disengagement. For example, the second user action may include no longer pressing on a touchscreen, or a trackpad associated with display 600. When the second action is not indicative of rejection the updated visual content may include a removal of the preview of visual content 635. In this regard, the email body 610 may be returned to its original state as illustrated in FIG. 6A.

As stated above, in some instances, an icon may be generated with the user content. In such an instance, the directional swipe indicative of use acceptance may be towards and terminate at or on the icon. In such an instance, if the directional swipe does not terminate at or on the icon, the second user action may be indicative of user rejection. FIG. 7B illustrates the example display 700 where the second user action 730b includes a direction swipe from the location on the display 700 of the first user action 730a along and terminating on icon 750. Icon 750 may change in appearance in response to the directional swipe (e.g., change color, size, font, etc.). Alternatively, if the directional swipe does not terminate at or on icon 750, the second user action may be indicative of user rejection.

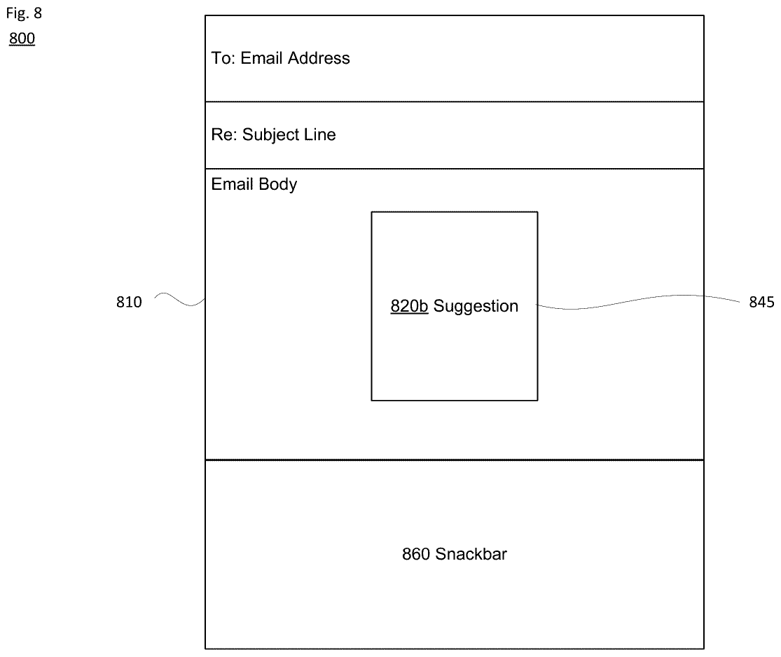

In some instances, the updated visual content may include a snackbar including an undo feature. The undo feature may allow a user to transition from the accepted state to the original state. FIG. 8 illustrates an example display 800 including snackbar 860. User engagement via one or more user mechanisms associated with display 800 with snackbar 860 may allow a user to revert from the final state, including accepted suggestion 820b in the updated visual content 845, to the original state.

The features and methodology described herein may provide systems capable of allowing a user to make a suggestion using one fluid motion or connected steps. Such functionality may cause increased user interest in a feature or in making a suggestion and overall increased user satisfaction.

While certain examples herein refer to a computing device and a mobile device performing certain operations, the technology may be used with different types of client devices, and is not limited to the specific types of devices identified in the examples.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computer-implemented method, comprising:
detecting, by one or more user input mechanisms of a user computing device, a first user action, wherein the first user action includes interaction with a suggestion of a plurality of suggestions;
generating, by one or more processors of the user computing device, content in response to the first user action, wherein the content includes a visual preview of the suggestion of the plurality of suggestions;
detecting, by the one or more user input mechanisms of the user computing device, a second user action, wherein the second user action is different from the first user action; and
generating, by the one or more processors of the user computing device, updated content for visual presentation based on the second user action.

2. The method of claim 1, wherein the one or more user input mechanisms include a touchscreen and wherein the first user action includes applying pressure on the touchscreen.

3. The method of claim 2, wherein the second user action includes no longer applying pressure on the touchscreen.

4. The method of claim 1, wherein the second user action includes a directional swipe in a particular direction along the user computing device.

5. The method of claim 4, wherein the directional swipe is along an axis of the user computing device.

6. The method of claim 4, wherein the directional swipe is towards and terminates at an icon of the visual preview.

7. The method of claim 4, wherein the directional swipe is indicative of user acceptance of the suggestion of the plurality of suggestions.

8. The method of claim 7, wherein the updated content includes a visual transition of the suggestion from the visual preview to an accepted state.

9. The method of claim 4, wherein the directional swipe is indicative of user rejection of the suggestion of the plurality of suggestions.

10. The method of claim 9, wherein the updated content includes removal of the visual preview.

11. The method of claim 1, wherein the plurality of suggestions includes a plurality of responses to an electronic message generated by a large language model (LLM).

12. The method of claim 1, further comprising generating haptic feedback in response to at least one of the first user action and the second user action.

13. A user computing device comprising:
one or more user input mechanisms configured to detect user actions; and
one or more processors operatively connected to the one or more user input mechanisms configured to:
generate, content in response to a first user action, wherein the content includes a visual preview of a suggestion of a plurality of suggestions and wherein the first user action includes interaction with the suggestion of the plurality of suggestions, and
generate updated content for visual presentation based on a second user action.

14. The user computing device of claim 13, wherein the one or more user input mechanisms include at least one of a touchscreen and a trackpad.

15. The user computing device of claim 13, wherein the user computing device is a mobile device or a laptop computer.

16. The user computing device of claim 13, wherein the second user action includes a directional swipe in a particular direction along the user computing device.

17. The user computing device of claim 16, wherein the directional swipe is along an axis of the user computing device.

18. The user computing device of claim 16, wherein the directional swipe is indicative of user acceptance of the suggestion of the plurality of suggestions or user rejection of the suggestion of the plurality of suggestions.

19. The user computing device of claim 18, wherein the directional swipe is along a first axis of the user computing device when indicative of user acceptance and along a second axis of the user computing device when indicative of user rejection.

20. The user computing device of claim 18, wherein the directional swipe is in a first direction along a first axis of the user computing device when indicative of user acceptance and in a second direction along the first axis of the user computing device when indicative of user rejection.
